(19) United States
(12) Patent Application Publication
(10) Pub. No.: US 2024/0278826 A1
(43) Pub. Date: Aug. 22, 2024

(54) HYDROSTATIC STEERING DEVICE FOR A UTILITY VEHICLE

(71) Applicant: DEERE & COMPANY, MOLINE, IL (US)

(72) Inventors: STEFAN BROCKE, MANNHEIM (DE); NORBERT FRITZ, ILVESHEIM (DE); RICHARD STARCK, FALKENSTEIN (DE); JONAS GASSMANN, SINSHEIM-WEILER (DE); FABIAN HARTMANN, NEHREN (DE)

(21) Appl. No.: 18/432,480

(22) Filed: Feb. 5, 2024

(30) Foreign Application Priority Data
Feb. 22, 2023 (DE) 102023104288.2

(51) Int. Cl. B62D 5/093; B62D 5/32

(52) U.S. Cl. CPC B62D 5/093; B62D 5/32

(57) ABSTRACT

A hydrostatic steering device for an agricultural utility vehicle including a steering orbitrol, which can be controlled via a steering handle and by which a dual-action steering cylinder can be extended in accordance with a steering operation occurring at the steering handle. Depending on the operation direction of the steering handle, a first orbitrol connection forms a supply fed from a hydraulic high-pressure source, and a second orbitrol connection forms a return which communicates with a hydraulic reservoir, to actuate opposing working chambers of the steering cylinder. A hydraulic leakage flow occurring between the first and second orbitrol connections can be compensated with regard to a hydraulic operation of the steering cylinder via a valve assembly communicating with the high-pressure source and the hydraulic reservoir.

### CROSS-REFERENCE TO RELATED APPLICATIONS

This application claims priority to German Patent Application No. 102023104288.2, filed Feb. 22, 2023, which is hereby incorporated by reference.

### FIELD OF THE DISCLOSURE

The disclosure relates to a hydrostatic steering device for a utility vehicle.

### BACKGROUND

Vehicle steering systems include a steering wheel, by means of which a steering metering valve in the form of an orbitrol, fed from a hydraulic pump with pressurized hydraulic fluid, can be actuated in order to control a connected hydraulic steering cylinder for adjusting steerable wheels of the vehicle.

### SUMMARY

The disclosure relates to a hydrostatic steering device for a utility vehicle, comprising a steering orbitrol, which can be controlled by means of a steering handle and by means of which a dual-action steering cylinder can be extended in accordance with a steering operation occurring at the steering handle, in that, depending on the operation direction of the steering handle, a first orbitrol connection forms a supply fed from a hydraulic high-pressure source, and a second orbitrol connection forms a return which communicates with a hydraulic reservoir, to actuate opposing working chambers of the steering cylinder.

Such an arrangement allows comfortable steering even of heavy utility vehicles, to which end the steering cylinder is connected, for example, to an Ackermann steering system to influence the position of steerable wheels of the utility vehicle. However, owing to system-induced leaks, the pressure gradient present between the first and second orbitrol connections leads to the occurrence of hydraulic losses within the steering orbitrol, so that the volumetric flow passing through the supply is ultimately reduced by a leakage flow flowing away via the return in the direction of the hydraulic reservoir. Measured against the steering operation of the steering handle, which is usually a steering wheel, this results in a reduced extension of the steering cylinder and thus of the wheel steering angle set at the steerable wheels of the utility vehicle. In addition, the pressure gradient between the two orbitrol connections during extension generally differs in magnitude from that during retraction, which then likewise applies to the leakage flows. In turn, this means that when the steering process is complete, that is, when the steerable wheels are straightened again, the steering handle does not fully assume its usual central or neutral position again. Over time, this results in drifting of the steering handle position relative to the wheel steering angle, which can be annoying for the operator.

The object of the present disclosure is therefore to develop a hydrostatic steering device of the type mentioned in the introduction to the effect that undesirable drifting of the steering handle position relative to the wheel steering angle is prevented or at least reduced to an extent acceptable to the operator.

This object is achieved by a hydrostatic steering device having the features of one or more of the following embodiments.

The hydrostatic steering device for a utility vehicle comprises a steering orbitrol, which can be controlled by means of a steering handle and by means of which a dual-action steering cylinder can be extended in accordance with a steering operation occurring at the steering handle, in that, depending on the operation direction of the steering handle, a first orbitrol connection forms a supply fed from a hydraulic high-pressure source, and a second orbitrol connection forms a return which communicates with a hydraulic reservoir, to actuate opposing working chambers of the steering cylinder. A hydraulic leakage flow occurring within the steering orbitrol between the first and second orbitrol connections can be compensated here with regard to a hydraulic operation of the steering cylinder by means of a valve assembly communicating with the high-pressure source and/or the hydraulic reservoir.

The steering device according to the disclosure makes it possible, by corresponding actuation of the valve assembly, to correct drifting of the steering handle position relative to the wheel steering angle by targeted equalization of a leak-induced hydraulic loss or excess causing this during operation of the steering cylinder. The steering handle is typically a steering wheel, which is connected mechanically to an input shaft of the steering orbitrol via a steering column. The steering cylinder can be part of a conventional Ackermann steering system but also an articulated steering system of the utility vehicle. In the latter case, there are usually two symmetrically arranged steering cylinders which are provided between the vehicle parts to be steered and are actuated in opposite directions to carry out the steering process.

The utility vehicle can be of any design and can originate from the agricultural or forestry field, for example, but also from the construction machinery field.

Advantageous developments of the hydrostatic steering device according to the disclosure can be found in one or more of the following embodiments.

With regard to the specific design of the valve assembly, there are various possibilities, which take account of different procedures with regard to drift correction.

According to a first embodiment of the hydrostatic steering system, therefore, it can be provided for the valve assembly to comprise, for equalizing a leak-induced hydraulic loss in one of the working chambers of the steering cylinder, an electrically operated proportional valve, which is connected to the high-pressure source and can be selectively connected on the outlet side to either of the two working chambers of the steering cylinder via an electrically operated shuttle valve.

In this case, a control unit (e.g., a controller including a processor and memory) can actuate the electrically operated proportional valve and/or the electrically operated shuttle valve such that a leak-induced hydraulic loss occurring in one of the working chambers of the steering cylinder owing to a steering process is equalized by targeted supply of hydraulic fluid on the part of the high-pressure source. It is possible to perform the equalization continuously during the entire steering process. A wheel steering angle corresponding to the current steering handle position is thus provided at all times. Depending on the operation direction of the steering handle, the shuttle valve is actuated such that in each case hydraulic fluid from the high-pressure source can be applied in a targeted manner via the proportional valve to the working chamber of the steering cylinder which is connected to the supply and thus is affected by the hydraulic loss.

The scope of the pressure gradient between the orbitrol connections, the operation characteristic exerted on the steering orbitrol via the steering handle, and the steering forces resulting therefrom have a critical influence on the leak-induced hydraulic loss occurring within the steering orbitrol. According to experience, this increases with the extent and speed of an operation of the steering handle by an operator. In some embodiments, the control unit therefore estimates the scope of the leak-induced hydraulic loss as a function of an ascertained pressure difference between the two orbitrol connections and as a function of the magnitude and/or change over time of a steering variable representing a steering operation of the steering handle or an extension of the steering cylinder. The pressure difference is ascertained, for example, by means of a first pressure sensor by sensing an operating pressure of the high-pressure source. In this case, the sensed operating pressure corresponds in good approximation to the pressure difference between the supply and return, since the hydraulic pressure in the hydraulic reservoir is always negligibly small in comparison. Additionally or alternatively, second and third pressure sensors are present, which are used for the comparison of the pressure conditions prevailing between the two orbitrol connections and thus between the supply and return. To ascertain the steering variable, a rotation angle sensor or displacement sensor interacting with the steering column or steering cylinder, respectively, can also be provided. The corresponding sensor signals are supplied to the control unit via a CAN data bus of the utility vehicle for evaluation. The estimation of the scope of the leak-induced hydraulic loss on the basis of the aforementioned variables can be carried out proceeding from an empirically ascertained relationship stored in the control unit.

According to a second embodiment of the hydrostatic steering device, it can be provided for the valve assembly to comprise an electrically operated proportional valve, which is connected on the outlet side to the hydraulic reservoir and can be selectively connected to either of the two working chambers of the steering cylinder via an electrically operated shuttle valve.

In this case, it is possible for a control unit to actuate the electrically operated proportional valve and/or the electrically operated shuttle valve such that a leak-induced hydraulic excess occurring in one of the working chambers of the steering cylinder owing to a steering process is directed into the hydraulic reservoir. A leak-induced hydraulic excess is generally produced because, when a steering process is performed, the pressure gradient and thus the leakage flow between the two orbitrol connections is greater in magnitude during extension than during retraction, and therefore an imbalance arises in this respect when the steerable wheels are straightened again. By corresponding actuation of the valve assembly, the hydraulic excess can be discharged in a targeted manner in the direction of the hydraulic reservoir as the steering process ends. This replaces the continuous compensation of the leakage flow provided in the first embodiment and results in a correspondingly reduced control complexity on the part of the control unit.

In this case too, the control unit can estimate the scope of the leak-induced hydraulic excess as a function of an ascertained pressure difference between the supply and return (and thus the two orbitrol connections) and as a function of the magnitude and/or change over time of a steering variable representing an extension of the steering cylinder. With regard to ascertaining these variables by sensor, reference is made to the explanations in connection with the first embodiment of the hydraulic steering device. In this case, the control unit estimates the scope of the leak-induced hydraulic excess by time integration of the difference in magnitude between the leakage flows observed during the steering process.

The above and other features will become apparent from the following detailed description and accompanying drawings.

### BRIEF DESCRIPTION OF THE DRAWINGS

The hydrostatic steering device according to the disclosure for a utility vehicle is described in more detail below with reference to the drawings. Here, identical reference signs relate to corresponding components or components which are comparable with respect to their function. In the drawings:

FIG. 1 shows a schematically illustrated first example embodiment of the hydrostatic steering device according to the disclosure;

FIG. 2 shows the course of the hydraulic volumetric flows within the steering device according to FIG. 1 during an extension phase;

FIG. 3 shows the course of the hydraulic volumetric flows within the steering device according to FIG. 1 during a retraction phase;

FIG. 4 shows a schematically illustrated second example embodiment of the hydrostatic steering device according to the disclosure;

FIG. 5 shows the course of the hydraulic volumetric flows within the steering device according to FIG. 3 during an extension phase; and

FIG. 6 shows the course of the hydraulic volumetric flows within the steering device according to FIG. 3 during a retraction phase.

### DETAILED DESCRIPTION

The embodiments or implementations disclosed in the above drawings and the following detailed description are not intended to be exhaustive or to limit the present disclosure to these embodiments or implementations.

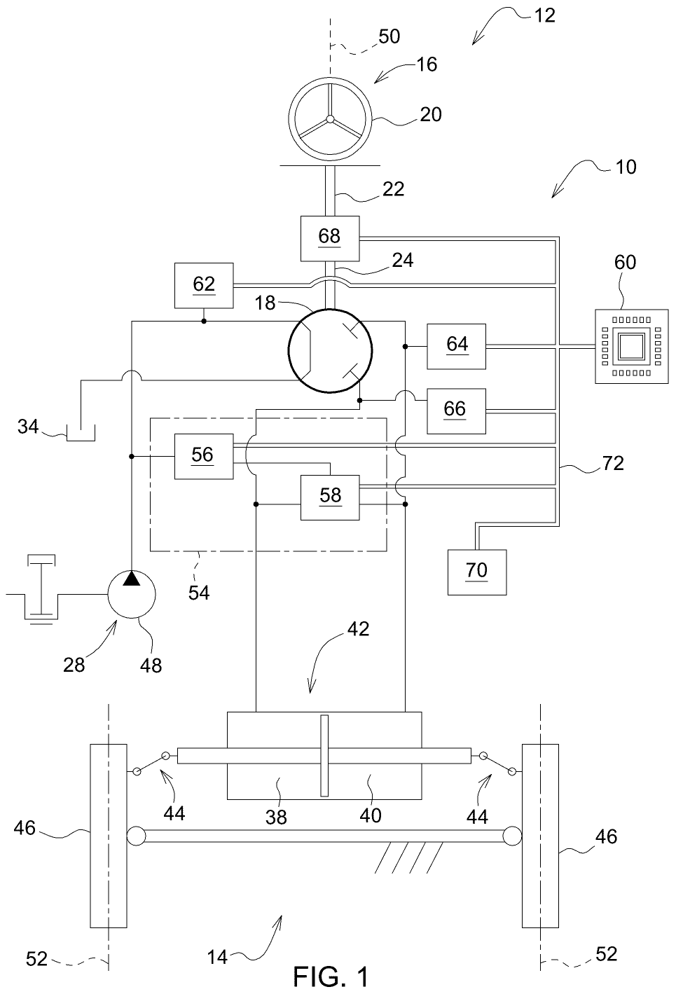

FIG. 1 shows a schematically illustrated first example embodiment of the hydrostatic steering device 10 according to the disclosure for a utility vehicle 12. By way of example, the utility vehicle 12 (not reproduced in detail) is an agricultural tractor 14. Alternatively, however, the utility vehicle 12 can also be of any other design from the agricultural or forestry field, as well as from the construction machinery field.

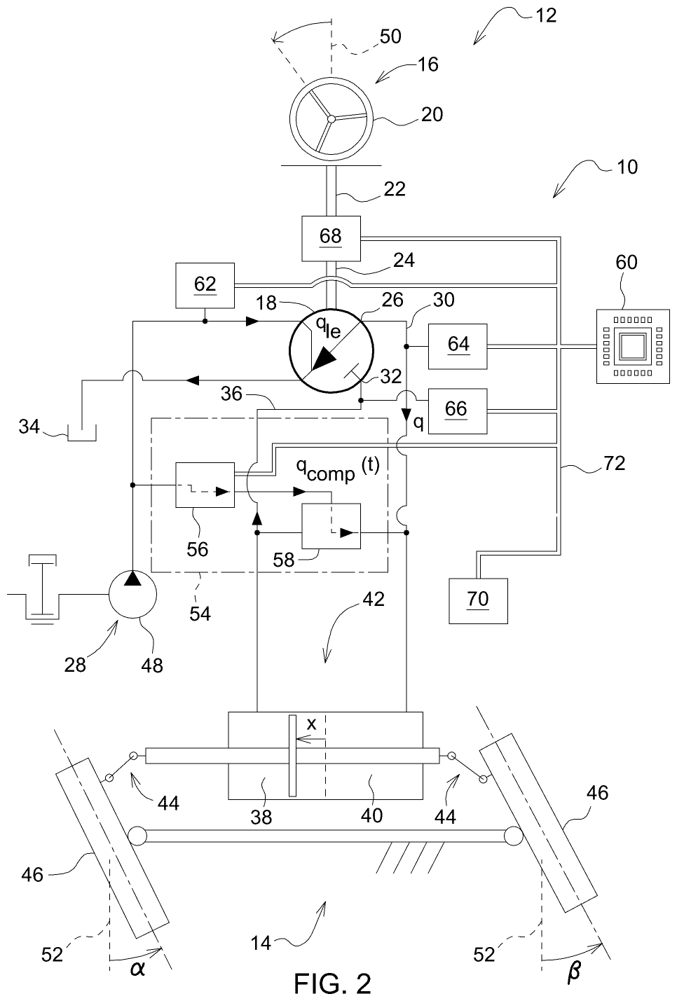

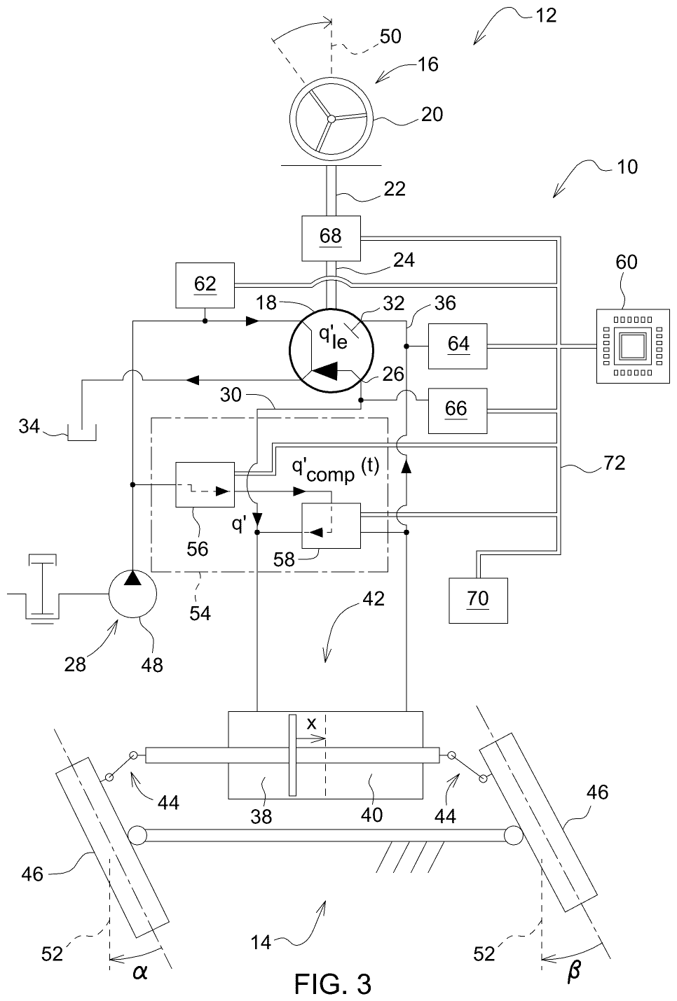

The hydrostatic steering device 10 comprises a steering orbitrol 18 which can be controlled by means of a steering handle 16. In some embodiments, the steering handle 16 is a steering wheel 20, which is connected mechanically to an input shaft 24 of the steering orbitrol 18 via a steering column 22. As can be seen in FIGS. 2 and 3, depending on the respective operation direction of the steering handle 16 and thus of the input shaft 24 of the steering orbitrol 18, a first orbitrol connection 26 forms a supply 30 fed from a hydraulic high-pressure source 28, and a second orbitrol connection 32 forms a return 36 which communicates with a hydraulic reservoir 34, to actuate opposing left and right working chambers 38, 40 of a dual-action steering cylinder 42 connected to the steering orbitrol 18. In this case, the steering cylinder 42 is part of a conventional Ackermann steering system 44 for influencing the position of steerable front wheels 46 of the agricultural tractor 14.

When the operation direction of the steering handle 16 changes, the function of the two orbitrol connections 26, 32 as supply and return 30, 36 reverses, wherein the scope of the steering operation determines the magnitude of the volumetric flows conveyed through the steering orbitrol 18. In this way, the steering cylinder 42 can be extended in accordance with the two possible driving directions of the utility vehicle 12 to set a desired wheel steering angle α, β. In this case, α denotes the wheel steering angle at the left and β denotes the wheel steering angle at the right of the two steerable front wheels 46, wherein α=β in the present case.

The hydraulic high-pressure source 28 is a motor-driven hydraulic pump 48, which is fed with hydraulic fluid from the hydraulic reservoir 34.

FIGS. 2 and 3 illustrate the course of the hydraulic volumetric flows within the steering device 10 during performance of a steering process including an extension phase (see FIG. 2) and a retraction phase (see FIG. 3). By way of example, a steering operation of the steering handle 16 to the left out of its centered central or neutral position 50 is carried out first, followed by steering back to the right. In this case, the centered central or neutral position 50 corresponds to a straight-ahead position 52 of the steerable front wheels 46 of the agricultural tractor 14.

Owing to system-induced leaks, the pressure gradient present between the first and second orbitrol connections 26, 32 leads to the occurrence of hydraulic losses within the steering orbitrol 18. The volumetric flow q or q′ passing through the supply 30 is therefore reduced by a leakage flow qₗₑ or q′ₗₑ, respectively, flowing away via the return 36 in the direction of the hydraulic reservoir 34. Measured against the steering operation of the steering handle 16, this results in a reduced extension x of the steering cylinder 42 and thus of the wheel steering angle α, β set at the steerable front wheels 46. In addition, the pressure gradient between the two orbitrol connections 26, 32 during extension generally differs in magnitude from that during retraction, which then likewise applies to the leakage flows qₗₑ and q′ₗₑ. In turn, this means that when the steering process is complete, that is, when the steerable front wheels 46 are straightened again, the steering handle 16 does not fully assume its central or neutral position 50 again. Over time, this results in drifting of the steering handle position relative to the wheel steering angle α, β.

In order to be able to equalize the leak-induced hydraulic loss causing this in the working chambers 38, 40 of the steering cylinder 42, the steering device 10 comprises a valve assembly 54 having an electrically operated proportional valve 56 which is connected to the high-pressure source 28 and can be selectively connected on the outlet side to either of the two working chambers 38, 40 of the steering cylinder 42 via an electrically operated shuttle valve 58. A control unit 60 actuates the electrically operated proportional valve 56 and/or the electrically operated shuttle valve 58 such that a leak-induced hydraulic loss occurring in one of the working chambers 38, 40 of the steering cylinder 42 owing to a steering process is equalized by targeted supply of hydraulic fluid on the part of the high-pressure source 28. In this case, the equalization is carried out continuously during the entire steering process by adjusting chronologically corresponding compensation flows q_{comp}(t)=−qₗₑ(t) and q′_{comp}(t)=−q′ₗₑ(t) via the valve assembly 54. A wheel steering angle α, β corresponding to the current steering handle position is thus provided at all times. As can be seen in FIGS. 2 and 3, the shuttle valve 58 is actuated depending on the operation direction of the steering handle 16 such that in each case hydraulic fluid from the high-pressure source 28 is applied in a targeted manner via the proportional valve 56 to the working chamber 38, 40 of the steering cylinder 42 which is connected to the supply 30 and thus is affected by the hydraulic loss. Therefore, by corresponding actuation of the valve assembly 54, drifting of the steering handle position relative to the wheel steering angle α, β is corrected by targeted equalization of a leak-induced hydraulic loss causing this during operation of the steering cylinder 42.

The scope of the pressure gradient between the orbitrol connections 26, 32, the operation characteristic exerted on the steering orbitrol 18 via the steering handle 16, and the steering forces resulting therefrom have a critical influence on the leak-induced hydraulic loss occurring within the steering orbitrol 18 and thus on the magnitude of the leakage flows qₗₑ and q′ₗₑ. The control unit 60 therefore estimates the scope of the leak-induced hydraulic loss as a function of an ascertained pressure difference between the two orbitrol connections 26, 32 and as a function of the magnitude and/or change over time of a steering variable representing a steering operation of the steering handle 16 or an extension x of the steering cylinder 42.

The pressure difference is ascertained by means of a first pressure sensor 62 by sensing an operating pressure of the high-pressure source 28. In this case, the sensed operating pressure corresponds in good approximation to the pressure difference between the supply and return 30, 36, since the hydraulic pressure in the hydraulic reservoir 34 is always negligibly small in comparison. Optionally, second and third pressure sensors 64, 66 can also be present, which are used for the direct comparison of the pressure conditions prevailing between the two orbitrol connections 26, 32 and thus between the supply and return 30, 36.

To ascertain the steering variable, a rotation angle sensor 68 or displacement sensor 70 interacting with the steering column 22 or steering cylinder 42, respectively, is also provided.

The corresponding sensor signals are supplied to the control unit 60 via a CAN data bus 72 of the agricultural tractor 14 for evaluation. The estimation of the scope of the leak-induced hydraulic loss or of the associated leakage flows qₗₑ and q′ₗₑ on the basis of the aforementioned variables is then carried out proceeding from an empirically ascertained relationship stored in the control unit 60.

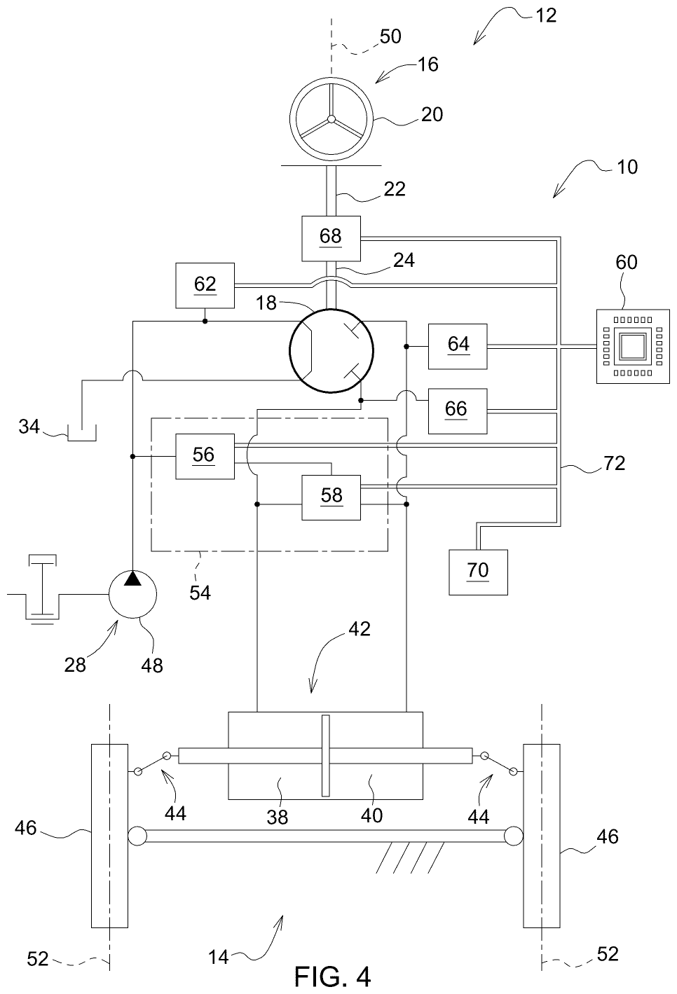

FIG. 4 shows a schematically illustrated second example embodiment of the hydraulic steering device 10 according to the disclosure for a utility vehicle 12. This differs from the first example embodiment in that the electrically operated proportional valve 56 included in the valve assembly 54 is not connected to the high-pressure source 28 but to the hydraulic reservoir 34. In this case too, the proportional valve 56 can be selectively connected on the outlet side to either of the two working chambers 38, 40 of the steering cylinder 42 via the electrically operated shuttle valve 58. This makes it possible to rectify a hydraulic excess Δqₗₑ occurring during the steering process for the purpose of drift correction instead of a direct equalization of the leak-induced hydraulic loss.

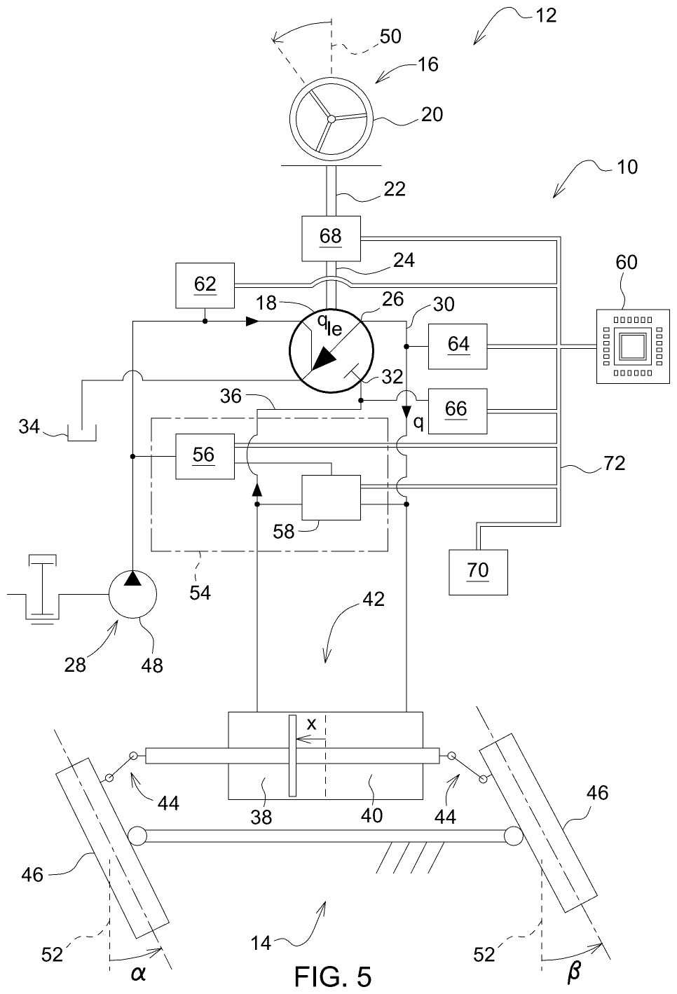

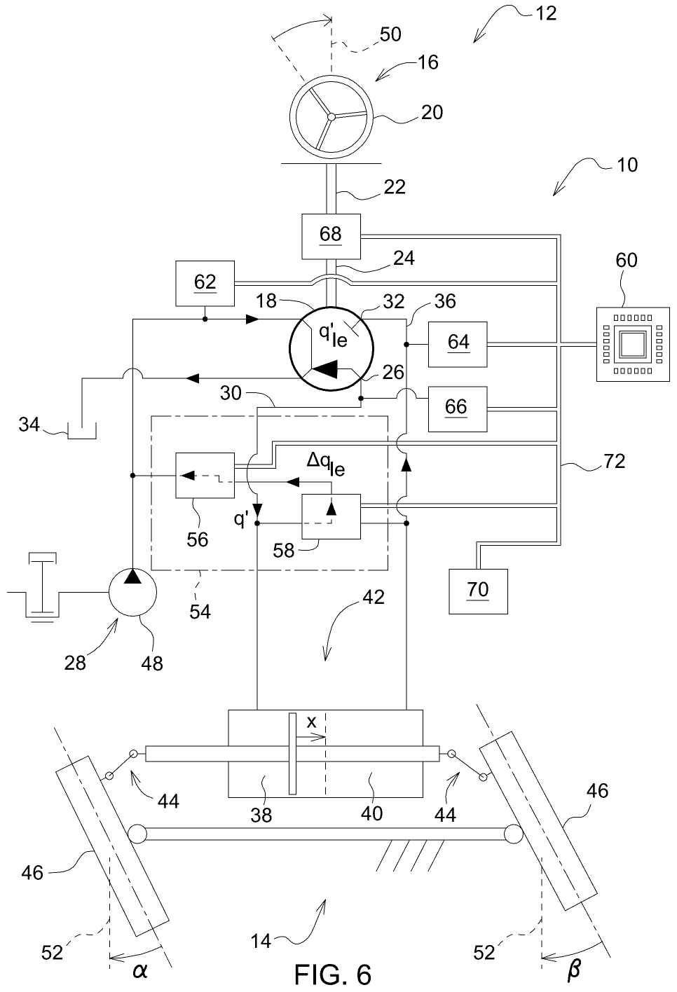

Such a leak-induced hydraulic excess Δqₗₑ is generally produced because, when a steering process is performed, the pressure gradient and thus the leakage flow between the two orbitrol connections 26, 32 is greater in magnitude during extension than during retraction, qₗₑ>q′ₗₑ. In this respect, FIGS. 5 and 6 illustrate the course of the hydraulic volumetric flows within the steering device 10 during performance of a steering process including an extension phase (see FIG. 5) and a retraction phase (see FIG. 6).

As can be seen in FIG. 6, the control unit 60 actuates the electrically operated proportional valve 56 and/or the electrically operated shuttle valve 58 such that the leak-induced hydraulic excess Δqₗₑ occurring in the left-hand working chamber 38 (in the present case) during extension and retraction is directed in a targeted manner into the hydraulic reservoir 34 as the steering process ends. This replaces the continuous compensation of the leakage flows qₗₑ and q′ₗₑ provided in the first example embodiment and results in a correspondingly reduced control complexity on the part of the control unit 60.

The control unit 60 estimates the scope of the leak-induced hydraulic excess Δqₗₑ by time integration of the difference in magnitude between the leakage flows qₗₑ and q′ₗₑ observed during the steering process. With regard to the ascertainment thereof, reference is made to the relevant statements in connection with the first example embodiment.

The steering device 10 according to the disclosure is thus based on the approach of correcting, by corresponding actuation of the valve assembly 54, drifting of the steering handle position relative to the wheel steering angle α, β by targeted equalization of a leak-induced hydraulic loss or excess causing this during operation of the steering cylinder 42.

Generally, the two embodiments of the hydrostatic steering device 10 described above make it possible, in different ways and instigated by the control unit 60, to compensate, with regard to a hydraulic operation of the steering cylinder 42, a hydraulic leakage flow qₗₑ, q′ₗₑ or Δqₗₑ occurring within the steering orbitrol 18 between the first and second orbitrol connections 26, 32 by means of the valve assembly 54 communicating with the high-pressure source 28 (FIGS. 2 and 3) and/or with the hydraulic reservoir 34 (FIGS. 5 and 6).

The valve assembly 54 is also designed such that the maximum through-flow is limited, even in the event of a malfunction, such that the steerability of the agricultural tractor 14 is not significantly impaired. The operator thus always retains control of the agricultural tractor 14.

It should also be noted that the procedure for drift correction described in connection with the two example embodiments applies analogously to the case of a steering operation of the steering handle 16 in the opposite direction. There are no further explanations in this respect to avoid repetitions.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A hydrostatic steering device for an agricultural utility vehicle, comprising:
a steering orbitrol, which can be controlled via a steering handle and by which a dual-action steering cylinder can be extended in accordance with a steering operation occurring at the steering handle;
depending on the operation direction of the steering handle, a first orbitrol connection forms a supply fed from a hydraulic high-pressure source, and a second orbitrol connection forms a return which communicates with a hydraulic reservoir, to actuate opposing working chambers of the steering cylinder; and
wherein a hydraulic leakage flow occurring between the first and second orbitrol connections can be compensated with regard to a hydraulic operation of the steering cylinder via a valve assembly communicating with the high-pressure source and the hydraulic reservoir.

2. The hydrostatic steering system of claim 1, wherein the valve assembly comprises an electrically operated proportional valve connected to the high-pressure source, the electrically operated proportional valve can be selectively connected on the outlet side to either of the opposing working chambers via an electrically operated shuttle valve for equalizing a leak-induced hydraulic loss in one of the opposing working chambers of the steering cylinder.

3. The hydrostatic steering device of claim 2, further comprising a controller configured to actuate the electrically operated proportional valve and the electrically operated shuttle valve such that a leak-induced hydraulic loss occurring owing to a steering process in one of the opposing working chambers of the steering cylinder is equalized by a targeted supply of hydraulic fluid on the part of the high-pressure source.

4. The hydrostatic steering device of claim 3, wherein the controller estimates the scope of the leak-induced hydraulic loss as a function of an ascertained pressure difference between the two orbitrol connections and as a function of the magnitude or change over time of a steering variable representing a steering operation of the steering handle or an extension of the steering cylinder.

5. The hydrostatic steering device of claim 1, wherein the valve assembly comprises an electrically operated proportional valve connected on the outlet side to the hydraulic reservoir and selectively connected to either of the opposing working chambers of the steering cylinder via an electrically operated shuttle valve.

6. The hydrostatic steering device of claim 5, further comprising a controller configured to estimate the scope of the leak-induced hydraulic excess as a function of an ascertained pressure difference between the two orbitrol connections and as a function of the magnitude or change over time of a steering variable representing an extension of the steering cylinder.

7. The hydrostatic steering device of claim 6, wherein the controller estimates the leakage-flow-induced hydraulic excess as a function of an ascertained pressure difference between the supply and return and as a function of the magnitude or change over time of a steering variable representing an extension of the steering cylinder.

8. An agricultural utility vehicle including a hydrostatic steering device, comprising:
a steering orbitrol, which can be controlled via a steering handle and by which a dual-action steering cylinder can be extended in accordance with a steering operation occurring at the steering handle;
depending on the operation direction of the steering handle, a first orbitrol connection forms a supply fed from a hydraulic high-pressure source, and a second orbitrol connection forms a return which communicates with a hydraulic reservoir, to actuate opposing working chambers of the steering cylinder; and
wherein a hydraulic leakage flow occurring between the first and second orbitrol connections can be compensated with regard to a hydraulic operation of the steering cylinder via a valve assembly communicating with the high-pressure source and the hydraulic reservoir.

9. The agricultural utility vehicle of claim 8, wherein the valve assembly comprises an electrically operated proportional valve connected to the high-pressure source, the electrically operated proportional valve can be selectively connected on the outlet side to either of the opposing working chambers via an electrically operated shuttle valve for equalizing a leak-induced hydraulic loss in one of the opposing working chambers of the steering cylinder.

10. The agricultural utility vehicle of claim 9, further comprising a controller configured to actuate the electrically operated proportional valve and the electrically operated shuttle valve such that a leak-induced hydraulic loss occurring owing to a steering process in one of the opposing working chambers of the steering cylinder is equalized by a targeted supply of hydraulic fluid on the part of the high-pressure source.

11. The agricultural utility vehicle of claim 10, wherein the controller estimates the scope of the leak-induced hydraulic loss as a function of an ascertained pressure difference between the two orbitrol connections and as a function of the magnitude or change over time of a steering variable representing a steering operation of the steering handle or an extension of the steering cylinder.

12. The agricultural utility vehicle of claim 8, wherein the valve assembly comprises an electrically operated proportional valve connected on the outlet side to the hydraulic reservoir and selectively connected to either of the opposing working chambers of the steering cylinder via an electrically operated shuttle valve.

13. The agricultural utility vehicle of claim 12, further comprising a controller configured to estimate the scope of the leak-induced hydraulic excess as a function of an ascertained pressure difference between the two orbitrol connections and as a function of the magnitude or change over time of a steering variable representing an extension of the steering cylinder.

14. The agricultural utility vehicle of claim 13, wherein the controller estimates the leakage-flow-induced hydraulic excess as a function of an ascertained pressure difference between the supply and return and as a function of the magnitude or change over time of a steering variable representing an extension of the steering cylinder.
